(19) United States
(12) Patent Application Publication
(10) Pub. No.: US 2009/0225216 A1
(43) Pub. Date: Sep. 10, 2009

(54) FL GRID TRANSMISSION CAMERA DEVICE

(76) Inventor: Suk Ho Yun, Seoul (KR)

Correspondence Address: PARK LAW FIRM, 3255 WILSHIRE BLVD, SUITE 1110, LOS ANGELES, CA, 90010, US

(21) Appl. No.: 11/721,089

(22) PCT Filed: Dec. 6, 2005
(86) PCT No.: PCT/KR05/04133

§ 371 Date: Jul. 12, 2007

(30) Foreign Application Priority Data
Dec. 7, 2004 (KR) 10-2004-0102599

(51) Int. Cl. H04N 5/232

(52) U.S. Cl. 348/347; 348/E05.045

(57) ABSTRACT

Disclosed is an image pickup device capable of transmitting a focal length grid in which a photographing range is displayed on a real image of the subject so as to photograph the composition of the real image, without viewing a view finder or a LCD monitor. The image pickup device comprising a lens assembly for photographing an image of a subject, a lens drive for controlling a focus of the lens assembly and a driving of a shutter, a light-emitting unit for irradiating a light towards the subject, a light-irradiating control unit for determining a shape of a frame irradiated directly to the subject and an irradiating range based on a variation of a photographing range, a light-irradiating button unit for operating the light-emitting unit, an operating panel unit for inputting various control commands by means of a user, a zoom managing unit for performing a zoom function of the operating panel unit, and a main control unit for controlling overall photographing operations of each unit.

### TECHNICAL FIELD

The present invention relates to an image pickup device capable of transmitting a focal length grid, and more particularly to an image pickup device capable of transmitting a focal length grid in which a photographing range is displayed on a real image of a subject so as to photograph the composition of the real image, without viewing a view finder or a LCD monitor.

### BACKGROUND ART

In a conventional image pickup device, user can previously see the composition or screen of the subject to be photographed through the view finder or the LCD monitor during the photographing thereof. However, where the user views the conventional view finder or LCD monitor, there are restrictions in that the user must close one eye thereof or the LCD monitor must be separated from his eye in a predetermined distance.

### DISCLOSURE OF INVENTION

### Technical Solution

Accordingly, the present invention has been made to solve the above-mentioned problems occurring in the prior art, and an object of the present invention is to provide an image pickup device capable of transmitting a focal length grid, in which an angle of view of a focal length designated by the user is displayed on the real image of the actual subject through a light-emitting unit, whereby the user can grasp the composition of the photograph in the actual frame and arrange the subject, without viewing the view finder or the LCD monitor.

### Advantageous Effects

In the an image pickup device capable of transmitting a focal length grid according to the present invention, an angle of view of a focal length designated by the user is displayed on the real image of the actual subject through a light-emitting unit and the user can grasp the composition of the photograph in the actual frame and arrange the subject, without viewing the view finder or the LCD monitor, thereby providing a convenience thereof.

### BRIEF DESCRIPTION OF THE DRAWINGS

The above as well as the other objects, features and advantages of the present invention will be more apparent from the following detailed description taken in conjunction with the accompanying drawings, in which:

FIG. 1 is a block diagram illustrating an image pickup device capable of transmitting a focal length grid according to the present invention;

FIG. 2 is a block diagram illustrating an image pickup device capable of transmitting a focal length grid according to another embodiment of the present invention;

FIG. 3 illustrates the AF point and the frame area of the FL grid displayed on a planar wall as the subject according to the present invention;

FIG. 4 illustrates the AF point and the frame area of the FL grid of the subject at a low angle according to the present invention; and

FIG. 5 is a perspective view illustrating an embodiment of the light-irradiating control unit of the image pickup device capable of transmitting a focal length grid according to the present invention.

### BEST MODE FOR CARRYING OUT THE INVENTION

A preferred embodiment of the invention will be described in detail below with reference to the accompanying drawings.

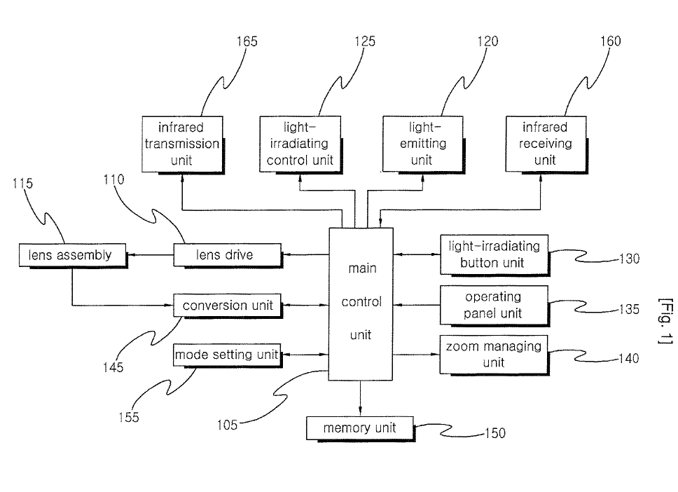

FIG. 1 is a block diagram illustrating an image pickup device capable of transmitting a focal length grid according to the present invention.

As shown in FIG. 1, the image pickup device capable of transmitting the focal length grid includes a lens assembly 115 for photographing an image of a subject, a lens drive 110 for controlling a focus of the lens assembly and a driving of a shutter, a light-emitting unit 120 for irradiating a light towards the subject, a light-irradiating control unit 125 for determining a shape of a frame irradiated directly to the subject and an irradiating range based on the variation of a photographing range, a light-irradiating button unit 130 for operating the light-emitting unit 120, an operating panel unit 135 for inputting various control commands by means of a user, a zoom managing unit 140 for performing a zoom function of the operating panel unit 135, and a main control unit 105 for controlling overall photographing operations of each unit.

More concretely, when the user presses the light-irradiating button unit 130 of the image pickup device according to the present invention, the light from the light-emitting unit 120 is irradiated to the real image of the subject so as to accurately grasp the position of the subject by using the central automatic focus (AF) point of the focus length (FL) grid mounted to the camera lens, thereby showing the frame to be photographed. Accordingly, it is unnecessary to check out the position and composition of the subject through the view finder or the LCD monitor. Here, the light-emitting unit 120 adjusts the focus of the subject through the AF point and the focus length (FL) grid shows the square frame together.

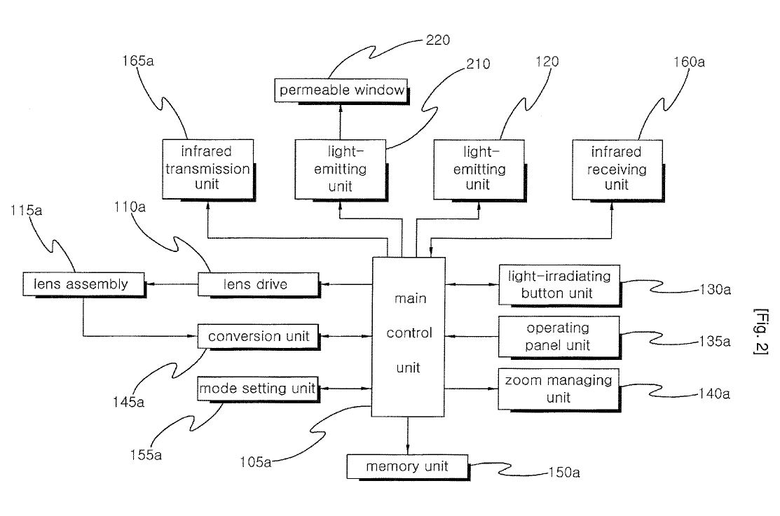

Meanwhile, in the illustrated case, the shape of the frame is only a square. However, the present invention is not limited to the frame having only a square. In accordance with the present invention, the shape of the frame may be a circle, an oval, a lozenge and so on. That is, the shape of a permeable window, as shown in FIG. 2, may be displayed on the real image in a various shape.

More concretely, when the user presses the light-irradiating button unit 130 of the image pickup device according to the present invention, the light is generated through the light-emitting unit 120 and is irradiated to the subject. Here, the irradiated central automatic focus (AF) point and area of the square frame show the range of the image formed in the image pickup device.

The light-irradiating control unit 125 serves to determine the shape of the frame irradiated directly to the subject and control the changed range of the photo irradiation in a case of changing the photographing range such as the zooming function and the change of a distance. More clearly, when the user manipulates the operating panel unit 135, the light-irradiating control unit 125 controls the range of the photo irradiation through the main control unit 105 according to the inputted order and displays it on the real image through the light-emitting unit 120.

According to an additional aspect of the present invention, the image pickup device capable of transmitting the focal length grid further includes an infrared transmission unit 165 irradiating the infrared light for checking out the existence and nonexistence of the subject and an infrared receiving unit 160 for receiving the reflected infrared light.

As described above, the infrared light is irradiated toward the subject through the infrared transmission unit 165 and the infrared light reflected from the subject is received by the infrared receiving unit 160 again, so that it can check out the existence and nonexistence of the subject. Here, where the subject does not exist, that is, when the region corresponding to the AF does not exist or the AF is infinity, the AF point and the square frame of the focal length grid are not displayed all together.

According to anther additional aspect of the present invention, the image pickup device capable of transmitting the focal length grid further includes a conversion unit 145 for converging the photographed image into a digital data and a memory unit 150 for storing the photographed images (the converged image data).

Accordingly, in case of applying the image pickup device of the present invention to the digital image pickup device, the pickup images of the subject are conversed into the digital data through the conversion unit 145 and the converged image data is stored in the memory unit 150.

According to further anther additional aspect of the present invention, the image pickup device capable of transmitting the focal length grid further includes a mode setting unit 155 for setting the frame ratio that is, the frame ratio mode of the FL grid to 4:3 mode or 3:3 mode and so on.

Accordingly, it can set the frame ratio mode of the FL grid to the frame ratio of 4:3 mode or 3:3 mode and so on, which are used in the digital image pickup device.

FIG. 2 is a block diagram illustrating an image pickup device capable of transmitting a focal length grid according to another embodiment of the present invention.

As shown in FIG. 2, a light-irradiating control unit of the image pickup device capable of transmitting the focal length grid includes a permeable window 220 for representing by a frame area in order to see the light irradiated toward the subject with the naked eye and a driving motor unit 210 for moving a light-emitting unit 120 during the changing of the photographing range according to the zooming function.

More concretely, when the user presses the light-irradiating button unit 130a of the image pickup device according to the present invention, the light from the permeable window 220 is irradiated to the real image of the subject so as to accurately grasp the position of the subject by using the central automatic focus (AF) point of the focus length (FL) grid mounted to the camera lens, thereby showing the frame to be photographed.

The light-emitting unit 120 is mechanically connected to the driving motor unit 210 and gets near to or away from the permeable window 220 according to the operation of the driving motor unit 210, so that the area of the FL grid frame, which is displayed on the real image according to the zooming function of a zoom managing unit 140a is enlarged or reduced.

More clearly, when the user manipulates the operating panel unit 135a, the operated signals are transmitted to each unit through the main control unit 105a to operate the zoom function, thereby performing the zoom function (enlargement or reduction) through the zoom managing unit 140a. At this time, since the photographing frame area is also changed according to the changing of the photographing range, the light-emitting unit 120 is moved to right and left.

The light is generated through the light-emitting unit 120 and is irradiated to the subject. Here, the irradiated central automatic focus (AF) point and area of the square frame show the range of the image formed in the image pickup device.

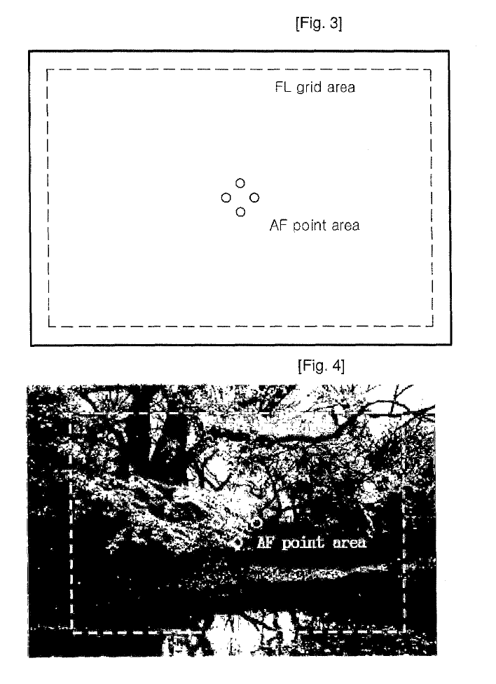

FIG. 3 illustrates the AF point and the frame area of the FL grid displayed on a planar wall as the subject according to the present invention.

As shown in FIG. 3, when the user presses the light-irradiating button unit 130 of the image pickup device according to the present invention, the AF point area and the frame area of the FL grid are transmitted at the same time, through the light-emitting unit 120, for example, the position of the wall as the subject is accurately grasped and the final photograph area is represented by the composition of the real image. At this time, when the user presses the light-irradiating button unit 130 again, only a part, which is located in the square frame displayed on the frame area of the FL grid, is stored as a final product or the image is formed on the film.

The light-irradiating button unit 130 includes automatic and semiautomatic shutters by reconstructing the photographing buttons of the conventional image pickup device. However, separate buttons can be organized. Preferably, the photographing button of the image pickup device of the present invention may be a photo irradiation button.

FIG. 4 illustrates the AF point and the frame area of the FL grid of the subject at a low angle according to the present invention.

As shown in FIG. 4, since the user can check out the photo image and the horizontal/vertical composition of the subject without viewing the view finder or the LCD monitor, the user can easily grasp the composition from the real image at low or high angles thereof by using the AF point and the frame area of the FL grid of the subject without lowering his body in order to check out the composition of the subject.

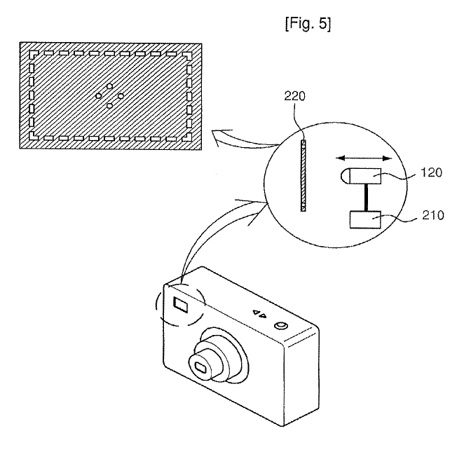

FIG. 5 is a perspective view illustrating an embodiment of the light-irradiating control unit of the image pickup device capable of transmitting a focal length grid according to the present invention.

As shown in FIG. 5, the light-irradiating control unit 125 serves to determine the shape of the frame irradiated directly to the subject and control the changed range of the photo irradiation in a case of changing the photographing range such as the zooming function and the change of a distance. More clearly, when the user manipulates the operating panel unit 135, the light-irradiating control unit 125 controls the range of the photo irradiation through the main control unit 105 according to the inputted order and displays it on the real image through the light-emitting unit 120.

Further more concretely, since the permeable window 220 according to the present invention is mounted on one side of the camera, where the user presses the light-irradiating button unit 130 of the image pickup device according to the present invention, the light is irradiated by the light-emitting unit 120 and the photographing range is represented by the composition of the real image according to the shape of the permeable window 220. At this time, where the user photographs the subject, only a part, which is located in the square frame displayed on the frame area of the FL grid, is stored as the final product or the image is formed on the film.

Here, when the user manipulates the zoom function of the operating panel unit 135, the operated signals are transmitted to each unit through the main control unit 105 to operate the zoom function, thereby performing the zoom function (enlargement or reduction) by moving the driving motor unit 210 connected to the main control unit 105 forward or backward.

While this invention has been described in connection with what are presently considered to be the most practical and preferred embodiments, it is to be understood that the invention is not limited to the disclosed embodiments and the drawings, but, on the contrary, it is intended to cover various modifications and variations within the spirit and scope of the appended claims.

1. An image pickup device capable of transmitting the focal length grid comprising:
a lens assembly for photographing an image of a subject;
a lens drive for controlling a focus of the lens assembly and a driving of a shutter;
a light-emitting unit for irradiating a light towards the subject;
a light-irradiating control unit for determining a shape of a frame irradiated directly to the subject and an irradiating range based on a variation of a photographing range;
a light-irradiating button unit for operating the light-emitting unit;
an operating panel unit for inputting various control commands by means of a user;
a zoom managing unit for performing a zoom function of the operating panel unit; and
a main control unit for controlling overall photographing operations of each unit.

2. An image pickup device capable of transmitting the focal length grid as claimed in claim 1, wherein the light-irradiating control unit comprises a permeable window for representing by a frame area in order to see the light irradiated toward the subject with the naked eye and a driving motor unit for moving the light-emitting unit during a changing of a photographing range according to the zooming function.

3. An image pickup device capable of transmitting the focal length grid as claimed in claim 1, further comprising an infrared transmission unit for irradiating an infrared light for checking out the existence and nonexistence of the subject and an infrared receiving unit for receiving a reflected infrared light.

4. An image pickup device capable of transmitting the focal length grid as claimed in claim 1, further comprising a conversion unit for converging the photographed image into a digital data and a memory unit for storing the photographed images.

5. An image pickup device capable of transmitting the focal length grid as claimed in claim 1, further comprising a mode setting unit for setting a frame ratio mode of the FL grid to 4:3 mode or 3:3 mode.

6. An image pickup device capable of transmitting the focal length grid as claimed in claim 2, further comprising an infrared transmission unit for irradiating an infrared light for checking out the existence and nonexistence of the subject and an infrared receiving unit for receiving a reflected infrared light.

7. An image pickup device capable of transmitting the focal length grid as claimed in claim 2, further comprising a conversion unit for converging the photographed image into a digital data and a memory unit for storing the photographed images.

8. An image pickup device capable of transmitting the focal length grid as claimed in claim 2, further comprising a mode setting unit for setting a frame ratio mode of the FL grid to 4:3 mode or 3:3 mode.
